(19) United States
(12) Patent Application Publication
(10) Pub. No.: US 2024/0143051 A1
(43) Pub. Date: May 2, 2024

(54) FLEXIBLE DISPLAY PORTABLE DEVICE

(71) Applicant: Sangkyu RYU, Uiwang-si (KR)

(72) Inventor: Sangkyu RYU, Uiwang-si (KR)

(21) Appl. No.: 18/280,157

(22) PCT Filed: Mar. 2, 2022
(86) PCT No.: PCT/KR2022/002959

§ 371 Date: Sep. 1, 2023

(30) Foreign Application Priority Data
Mar. 1, 2021 (KR) 10-2021-0027099
Mar. 4, 2021 (KR) 10-2021-0028876

(51) Int. Cl. G06F 1/20; G06F 1/16; G09F 9/30

(52) U.S. Cl. CPC G06F 1/206; G06F 1/1652; G06F 1/1681; G09F 9/301

(57) ABSTRACT

The present invention is intended to remove screen wrinkles and screen loosening in a flexible display folder-type device and provide waterproof and dustproof functions to the folder-type device. The present invention is intended to provide smooth functioning of a flexible display device by providing a temperature maintenance system that maintains the temperature of the flexible display device within a certain range in order to solve the problem of the device becoming damaged and not operating properly due to a change in temperature.

### TECHNICAL FIELD

The present disclosure relates to a flexible display portable device having an independent hinge structure and a flexible display portable device having a temperature maintenance system.

### BACKGROUND ART

Recently, a foldable device using a flexible display has been commercialized.

However, in most foldable devices, such as fold-in devices or fold-out devices, wrinkles and screen lifting occur on a screen, and problems in terms of water and dust proof arise due to a hinge structure. Therefore, there is a need to improve this.

In addition, devices using flexible displays have been introduced in various ways. Various forms such as foldable, rollable, slider, and wearable devices have been introduced. However, in these devices, there is a problem that a display unit does not work properly and is damaged due to temperature changes.

### DISCLOSURE

### Technical Problem

Recently, a foldable device using a flexible display has been commercialized.

However, in most foldable devices, such as fold-in devices or fold-out devices, wrinkles and screen lifting occur on a screen, and problems in terms of water and dust proof arise due to a hinge structure. Therefore, there is a need to improve this.

The present disclosure provides providing desired functionality of a flexible display device by providing a temperature maintenance system for maintaining the temperature of a flexible display device within a certain range to resolve a problem that such a device does not operate properly and is damaged due to temperature changes when the device is folded or slide.

### Technical Solution

The present disclosure resolves a problem caused by separation between a display and a body housing according to an operation of a hinge by proposing a foldable body housing 100 and an independent hinge part 200 to prevent screen wrinkles and screen lifting and to achieve waterproof and dustproof in a flexible display foldable device.

A strong supporting force is provided when all devices that are practically required for the body housing 100 are folded or unfolded via an operation of the independent hinge part 200.

The exterior of the body housing may be surrounded with a flexible material or surrounded with metal or plastic, and a combination of the two may be used.

The body housing 100 may be manufactured in a relatively flexible form with an articulated plate 101, and the body housing 100 includes a housing coupling protrusion and a groove 102 that are coupled to the independent hinge part 200, and thus the housing coupling protrusion and the groove 102 are coupled to a coupling groove or protrusion 206 of the independent hinge part 200, thereby forming one device. A coupling position of the two may be changed depending on a manufacturing method. According to folding or unfolding, the coupling groove or the protrusion may be fastened at a point in which folding and unfolding operations end. In addition, any form in which the independent hinge part is retracted into or surrounded around the body housing 100 is possible.

In some cases, very few devices that are not related to waterproofing and dustproofing may be installed on the independent hinge part 200 and may provide data on folding and unfolding.

The independent hinge part 200 may be made in a partially open structure, for example, an open form with various patterns of holes, which means that a lower surface of the body housing is to be visually seen and means an open form that various foreign substances enter and exit.

The independent hinge part 200 may be made to be fold-in, fold-out, and fold-in-and-out, and may be applied to various folding devices that are folded twice or more.

To absorb a shock when the independent hinge part 200 and the body housing are combined and folded or unfolded, a shock absorber such as a spring 203 or a damper 204 equipped with a hydraulic pump may be provided, and a device such as a rubber packing 202 may be employed.

To have separation and stability of the independent hinge part 200 and the body housing 100, the coupler spring 203 and the damper 204 may be installed anywhere in the body housing 100 and the independent hinge part 200.

The independent hinge part 200 may mean an area separated from the body housing 100, and thus various existing hinge structures may be adopted.

Another object of the present disclosure is to provide a temperature maintenance system of a flexible display device that provides the temperature of the flexible display device within a certain range.

A sensor for detecting the temperature and a controller for recognizing and controlling this may be provided in the flexible display device.

When the temperature of the flexible display device is out of a certain range, this may be notified to a user in the form of an image, voice, vibration, or the like to limit a specific operation such as defining of a display.

A heating wire 1200 installed in the device may be driven to raise the temperature of the device. In contrast, when the temperature inside the device is excessively raised, power consumption may be reduced and the temperature inside the device may be lowered by selectively limiting software or hardware functions that are not actually used. Needless to say, the temperature may be raised by additionally operating software or hardware functions, like the heating wire 1200.

A position at which the heating wire is installed may be a lower end of a flexible display 1100 or an inner surface of a device housing 1101. A heating wire means a line that generates heat, and a material of the heating wire is not limited.

This temperature range may be set by a manufacturer or allowed to be selected by a user.

When the temperature maintenance system is not provided inside the device, the heating wire 1200 may be installed in a separate outer case 1102, a pouch, or the like, and the case or the pouch may be powered by a portable battery to raise the temperature of the flexible display device.

A behavior of a user may be restricted by notifying the current temperature range by attaching an outer surface of the housing, an external screen, a case, or a sticker having a change in color or pattern according to a temperature change.

According to the present disclosure, it may be possible to use the flexible display device within a stable temperature range even in severe cold or hot weather by maintaining the temperature of the flexible display device within a certain range, thereby preventing damage to the device.

A warning may be given to a user in advance according to weather changes related to temperature to provide information on a device usage behavior of the user, thereby blocking an act of damaging the device.

When the use of the device is inappropriate due to a change in temperature, a component is provided to raise the internal temperature of the device to operate normally, thereby preventing damage to the device.

The present disclosure is not limited to the examples described above, and includes all technologies belonging to similar technical scopes.

### Advantageous Effects

The present disclosure has an effect of providing waterproof and dustproof by removing screen wrinkles and screen lifting in a flexible display foldable device.

The present disclosure has an effect of providing desired functionality of a flexible display device by providing a temperature maintenance system for maintaining the temperature of a flexible display device within a certain range to resolve a problem that such a device does not operate properly and is damaged due to temperature changes.

### DESCRIPTION OF DRAWINGS

FIG. 1 is a diagram showing a first example of a body housing and an independent hinge part.

FIG. 2 is a diagram showing a second example of a body housing and an independent hinge part.

FIG. 3 is a diagram showing a third example of a body housing and an independent hinge part.

FIG. 4 is a diagram showing an example in which a heating wire 1200 installed at a lower end of a flexible display 1100 is disposed.

FIG. 5 is a diagram showing an example in which a heating wire 1200 is disposed inside a flexible display device housing 1101.

FIG. 6 is a diagram showing an example of a temperature display device 1201 is disposed in a flexible display device case 1102.

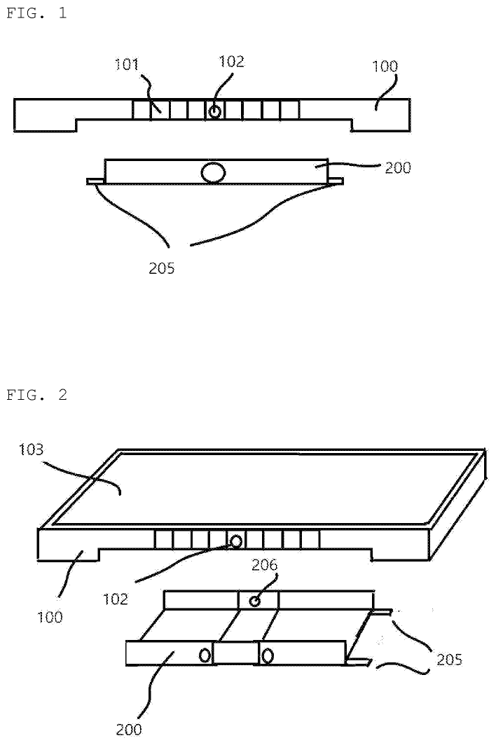

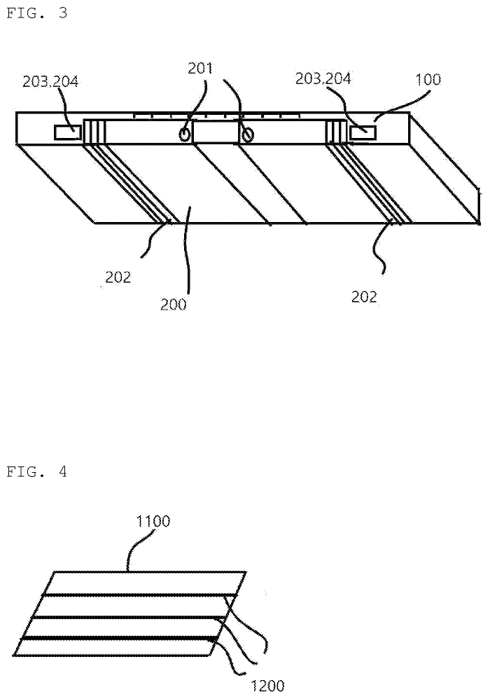

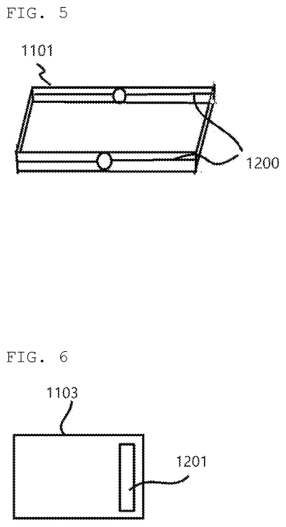

### BEST MODE

The present disclosure resolves a problem caused by separation between a display and a body housing according to an operation of a hinge by proposing a foldable body housing 100 and an independent hinge part 200 to prevent screen wrinkles and screen lifting and to achieve waterproof and dustproof in a flexible display foldable device.

A strong supporting force is provided when all devices that are practically required for the body housing 100 are folded or unfolded via an operation of the independent hinge part 200.

The exterior of the body housing may be surrounded with a flexible material or surrounded with metal or plastic, and a combination of the two may be used.

The body housing 100 may be manufactured in a relatively flexible form with an articulated plate 101, and the body housing 100 includes a housing coupling protrusion and a groove 102 that are coupled to the independent hinge part 200, and thus the housing coupling protrusion and the groove 102 are coupled to a coupling groove or protrusion 206 of the independent hinge part 200, thereby forming one device. A coupling position of the two may be changed depending on a manufacturing method. According to folding or unfolding, the coupling groove or the protrusion may be fastened at a point in which folding and unfolding operations end. In addition, any form in which the independent hinge part is retracted into or surrounded around the body housing 100 is possible.

In some cases, very few devices that are not related to waterproofing and dustproofing may be installed on the independent hinge part 200 and may provide data on folding and unfolding.

The independent hinge part 200 may be made in a partially open structure, for example, an open form with various patterns of holes, which means that a lower surface of the body housing is to be visually seen and refers to an open form that various foreign substances enter and exit.

The independent hinge part 200 may be made to be fold-in, fold-out, and fold-in-and-out, and may be applied to various folding devices that are folded twice or more.

To absorb a shock when the independent hinge part 200 and the body housing are combined and folded or unfolded, a shock absorber such as a spring 203 or a damper 204 equipped with a hydraulic pump may be provided, and a device such as a rubber packing 202 may be employed.

To have separation and stability of the independent hinge part 200 and the body housing 100, the coupler spring 203 and the damper 204 may be installed anywhere in the body housing 100 and the independent hinge part 200.

The independent hinge part 200 may mean an area separated from the body housing 100, and thus various existing hinge structures may be adopted.

Another object of the present disclosure is to provide a temperature maintenance system of a flexible display device that provides the temperature of the flexible display device within a certain range.

A sensor for detecting the temperature and a controller for recognizing and controlling this may be provided in the flexible display device.

When the temperature of the flexible display device is out of a certain range, this may be notified to a user in the form of an image, voice, vibration, or the like to limit a specific operation such as defining of a display.

A heating wire 1200 installed in the device may be driven to raise the temperature of the device. In contrast, when the temperature inside the device is excessively raised, power consumption may be reduced and the temperature inside the device may be lowered by selectively limiting software or hardware functions that are not actually used. Needless to say, the temperature may be raised by additionally operating software or hardware functions, like the heating wire 1200.

A position at which the heating wire is installed may be a lower end of a flexible display 1100 or an inner surface of a device housing 1101. A heating wire means a line that generates heat, and a material of the heating wire is not limited.

This temperature range may be set by a manufacturer or allowed to be selected by a user.

When the temperature maintenance system is not provided inside the device, the heating wire 1200 may be installed in a separate outer case 1102, a pouch, or the like, and the case or the pouch may be powered by a portable battery to raise the temperature of the flexible display device.

A behavior of a user may be restricted by notifying the current temperature range by attaching an outer surface of the housing, an external screen, a case, or a sticker having a change in color or pattern according to a temperature change.

According to the present disclosure, it may be possible to use the flexible display device within a stable temperature range even in severe cold or hot weather by maintaining the temperature of the flexible display device within a certain range, thereby preventing damage to the device

A warning may be given to a user in advance according to weather changes related to temperature to provide information on a device usage behavior of the user, thereby blocking an act of damaging the device.

When the use of the device is inappropriate due to a change in temperature, a component is provided to raise the internal temperature of the device to operate normally, thereby preventing damage to the device.

The present disclosure is not limited to the examples described above, and includes all technologies belonging to similar technical scopes
100: body housing 101: articulated plate 102: housing coupling protrusion and groove 103: display unit
200: independent hinge part 201: hinge axis 202: rubber packing 203: spring 204: damper
205: coupling bar 206: independent hinge part coupling groove or protrusion
1100: flexible display 1101: flexible display device housing 1102: outer case 1200: heating wire
1201: temperature display device

### INDUSTRIAL AVAILABILITY

A flexible display foldable device having an independent hinge structure and a temperature maintenance system of a flexible display device may be applicable to a device using a flexible display.

1. A flexible display portable device comprising one or more independent hinge structures to be coupled to an independent body housing.

2. A flexible display portable device comprising a temperature maintenance system using a heating wire and software control.

3. A flexible display portable device comprising a temperature maintenance system having a notification function including color, warning sound, and an image change depending on a temperature change or a detachable accessory.
